(19) United States
(12) Patent Application Publication
(10) Pub. No.: US 2022/0053349 A1
(43) Pub. Date: Feb. 17, 2022

(54) RADIO LINK MONITORING METHOD, DEVICE AND STORAGE MEDIUM

(71) Applicant: GUANGDONG OPPO MOBILE TELECOMMUNICATIONS CORP., LTD., Dongguan (CN)

(72) Inventors: Zuomin WU, Dongguan (CN); Chuanfeng He, Dongguan (CN)

(73) Assignee: GUANGDONG OPPO MOBILE TELECOMMUNICATIONS CORP., LTD., Dongguan (CN)

(21) Appl. No.: 17/476,968

(22) Filed: Sep. 16, 2021

Related U.S. Application Data
(63) Continuation of application No. PCT/CN2019/079146, filed on Mar. 21, 2019.

(51) Int. Cl. H04W 24/08; H04L 5/00; H04L 1/20; H04L 1/00; H04W 72/04

(52) U.S. Cl. CPC H04W 24/08; H04L 5/0051; H04W 72/044; H04L 1/0038; H04L 1/203

(57) ABSTRACT

Embodiments of the present disclosure provide a radio link monitoring method, device and storage medium, the method including: determining a bandwidth part BWP to be monitored, where the BWP to be monitored includes a plurality of subbands; performing radio link monitoring on the BWP to be monitored according to a target RLM-RS resource on at least one subband in the plurality of subbands, and the target RLM-RS resource is used to transmit the target RLM-RS. The radio link monitoring method, device and storage medium provided by the embodiments of the present disclosure can reduce an influence on a radio link monitoring result when a network device cannot send a target RLM-RS through part of the subbands, and improve an accuracy of radio link monitoring.

### CROSS-REFERENCE TO RELATED APPLICATIONS

This application is a continuation of International Application No. PCT/CN2019/079146 filed on Mar. 21, 2019, the entire content of which is incorporated herein by reference in its entirety.

### TECHNICAL FIELD

Embodiments of the present disclosure relate to communication technologies, and in particular, to a radio link monitoring method, device and storage medium.

### BACKGROUND

In mobile communication, a base station communicates with a terminal device on radio carrier. After radio connection is established, a physical layer of the terminal device needs to periodically monitor quality of the radio link.

At present, for a licensed spectrum, in a specific radio link monitoring process, the terminal device periodically realizes monitoring of a radio link by measuring quality of a reference signal on the licensed spectrum. When the quality of the measured reference signal is lower than a preset threshold, it is determined that the radio link is in out-of-sync (OOS) state, and the physical layer will send out-of-sync (OOS) instruction to a high layer of the terminal device (such as radio resource control (RRC) layer). When the quality of the measured reference signal is higher than another threshold, it is determined that the radio link is in the in-sync (IS) state, and the physical layer will send in-sync (IS) instruction to the high layer (RRC layer) of the terminal device.

In 5th generation cellular mobile communication (5G), radio link monitoring (RLM) mechanism is also used to detect quality of downlink radio links. Because the 5G communication system divides a bandwidth into several bandwidth parts (BWP), for an unlicensed spectrum, BWP can also include a plurality of listen before talk (LBT) subbands. When the network device only transmits the reference signal through part of the subbands, how to effectively monitor the downlink radio link quality is a current technical problem urgently to be solved.

### SUMMARY

Embodiments of the present disclosure provide a radio link monitoring method, device and storage medium, which can reduce an influence on a radio link monitoring result when a network device cannot send a target RLM-RS through part of the subbands, and improve an accuracy of radio link monitoring.

A first aspect, an embodiment of the present disclosure provides a radio link monitoring method, including:

determining a bandwidth part BWP to be monitored, and the BWP to be monitored includes a plurality of subbands;

performing radio link monitoring on the BWP to be monitored according to a target radio link monitoring-reference signal RLM-RS resource on at least one subband in the plurality of subbands, where the target RLM-RS resource is used to transmit the target RLM-RS.

A second aspect, an embodiment of the present disclosure provides a radio link monitoring method, including:

evaluating whether downlink radio link quality on a configured radio link monitoring-reference signal RLM-RS resource is lower than an out-of-sync threshold within an out-of-sync evaluation period, where the RLM-RS resource is used to transmit RLM-RS, the out-of-sync threshold corresponds to a physical downlink control channel PDCCH transmission parameter, and the PDCCH transmission parameter includes a first energy ratio, and where,

the first energy ratio includes a ratio of a resource element RE energy of the PDCCH to RE energy of the RLM-RS; and/or,

the first energy ratio includes a ratio of RE energy of a demodulation reference signal DMRS of the PDCCH to the RE energy of the RLM-RS.

A third aspect, an embodiment of the present disclosure provides a terminal device, including:

a determining module, configured to determine a bandwidth part BWP to be monitored, where the BWP to be monitored includes a plurality of subbands;

a processing module, configured to perform radio link monitoring on the BWP to be monitored according to a target radio link monitoring-reference signal RLM-RS resource on at least one subband in the plurality of subbands, where the target RLM-RS resource is used to transmit the target RLM-RS.

A fourth aspect, an embodiment of the present disclosure provides a terminal device, including:

a processing module, configured to evaluate whether downlink radio link quality on a configured radio link monitoring-reference signal RLM-RS resource is lower than an out-of-sync threshold within an out-of-sync evaluation period, where the RLM-RS resource is used to transmit RLM-RS, the out-of-sync threshold corresponds to a physical downlink control channel PDCCH transmission parameter, and the PDCCH transmission parameter includes a first energy ratio, and where, the first energy ratio includes a ratio of a resource element RE energy of the PDCCH to RE energy of the RLM-RS; and/or,

the first energy ratio includes a ratio of RE energy of a demodulation reference signal DMRS of the PDCCH to the RE energy of the RLM-RS.

A fifth aspect, an embodiment of the present disclosure provides a terminal device, including:

a processor, a memory and an interface communicating with network device;

the memory stores a computer execution instruction;

the processor executes the computer execution instruction stored in the memory, causing the processor to execute the radio link monitoring method as described in the first aspect or the radio link monitoring method as described in the second aspect.

A sixth aspect, an embodiment of the present disclosure provides a computer-readable storage medium, where the computer-readable storage medium stores computer execution instructions, which, when executed by the processor, is used to implement the radio link monitoring method as described in the first aspect or the radio link monitoring method as described in the second aspect.

A seventh aspect, an embodiment of the present disclosure provides a program, which, when executed by a processor, is used to execute the radio link monitoring method as described in any one of the above first aspect or the radio link monitoring method described in any one of the second aspect.

In an embodiment, the above-mentioned processor may be a chip.

An eighth aspect, an embodiment of the present disclosure provides a computer program product, including a program instruction, which is used to implement the radio link monitoring method described in any one of the first aspect or the radio link monitoring method described in any one of the second aspect.

A ninth aspect, an embodiment of the present disclosure provides a chip, including a processing module and a communication interface, which can execute the radio link monitoring method described in any one of the first aspect or the radio link monitoring method described in any one of the second aspect.

In an embodiment, the chip further includes a storing module (e.g., a memory) for storing an instruction, and the processing module is used for executing the instruction stored in the storing module, and execution of the instruction stored in the storing module causes the processing module to execute the radio link monitoring method described in any one of the first aspect or the radio link monitoring method described in any one of the second aspect.

The radio link monitoring method, device and storage medium provided by the embodiments of the present disclosure, by determining a BWP to be monitored, and then by performing radio link monitoring on the BWP to be monitored according to a target RLM-RS resource on at least one subband in the plurality of subbands of the BWP to be monitored, so as to reduce the influence on the radio link monitoring result when the network device cannot send a target RLM-RS through part of the subbands, and improve the accuracy of radio link monitoring.

### BRIEF DESCRIPTION OF DRAWINGS

To describe the technical solutions in embodiments of the present disclosure or in the prior art clearer, the following briefly introduces the accompanying drawings needed for describing the embodiments or the prior art. Apparently, the accompanying drawings in the following description are merely some embodiments of the present disclosure, and persons of ordinary skill in the art may still obtain other accompanying drawings from these accompanying drawings without creative effort.

FIG. 1 is a schematic diagram of a network device sending data to a terminal device through BWP0;

FIG. 2 is a schematic diagram of a communication system applied to an embodiment of the present disclosure;

FIG. 3 is an implementation flow chart of a radio link monitoring method provided by the present disclosure:

FIG. 4a is a schematic diagram of subbands in a BWP;

FIG. 4b is a schematic diagram of subbands for transmitting a target RLM-RS:

FIG. 4c is another schematic diagram of subbands for transmitting a target RLM-RS;

FIG. 4d is another schematic diagram of subbands;

FIG. 5 is a structural diagram of embodiment one of a terminal device provided by the present disclosure;

FIG. 6 is a structural diagram of embodiment two of a terminal device provided by the present disclosure; and

FIG. 7 is a structural diagram of embodiment three of a terminal device provided by the present disclosure.

### DESCRIPTION OF EMBODIMENTS

In order to make objectives, technical solutions and advantages in embodiments of the present disclosure clearer, technical solutions in the embodiments of the present disclosure will be described clearly and completely below in combination with the accompanying drawings in the embodiments of the present disclosure. Apparently, the described embodiments are merely a part rather than all embodiments of the present disclosure. All other embodiments obtained by persons of ordinary skill in the art based on embodiments of the present disclosure without creative effort shall fall within the protection scope of the present disclosure.

The terms “first”, “second” and the like in the description, claims and the above accompanying drawings of the embodiments of the present disclosure are used to distinguish similar objects, and are not necessarily used to describe a specific order or sequence. It should be understood that data used in this way can be interchanged under appropriate circumstances, so that the embodiments of the present disclosure described herein can be implemented, for example, in a sequence other than those illustrated or described herein. In addition, the terms “include” and “have” and any variation of them are intended to cover non-exclusive inclusion. For example, a process, method, system, product or device that contains a series of steps or units need not be limited to those steps or units clearly listed, but may include other steps or units that are not clearly listed or are inherent to these processes, methods, products or devices.

In the following, some terms in the present disclosure will be explained to facilitate the understanding of those skilled in the art.

1) Bandwidth part (BWP) refers to a part of a channel bandwidth, which can also be called as “carrier bandwidth part”, “operating bandwidth” or transmission bandwidth. The name and abbreviation of the bandwidth part are not specifically defined in the embodiments of the present disclosure. BWP can be a section of continuous or discontinuous resource in a frequency domain. For example, a bandwidth part contains continuous or discontinuous K subcarriers; or, a bandwidth part is frequency domain resource where N non-overlapping continuous or discontinuous resource blocks are located; or, a bandwidth part is frequency domain resource where M non-overlapping continuous or discontinuous resource block groups (RBG) are located, and one RBG includes P continuous RBs. In addition, for an unlicensed spectrum, a bandwidth part can also include Q listen before talk (LBT) subbands, where K. N, M, P and Q are integers greater than 0.

2) Unlicensed spectrum, a communication device needs follow a principle of “listen before talk (LBT)”, that is, the communication device needs to listen to a channel before sending a signal on the channel of the unlicensed spectrum. Only when a channel listening result is that the channel is idle, the communication device can send the signal, if the channel listening result of the communication device on the channel of the unlicensed spectrum is that the channel is busy, the communication device cannot send the signal. In order to ensure fairness, in one transmission, the time for the communication device to use an unlicensed spectrum channel for signal transmission should not be longer than a maximum channel occupancy time (MCOT); and in order to avoid that power of the signal transmitted on the unlicensed spectrum channel is too large, which will affect a transmission of other important signals on the channel, such as a transmission of a radar signal, the communication device needs to follow a limitation that the signal transmission power does not exceed a maximum transmission power and a maximum transmission power spectrum density when using the unlicensed spectrum channel for signal transmission.

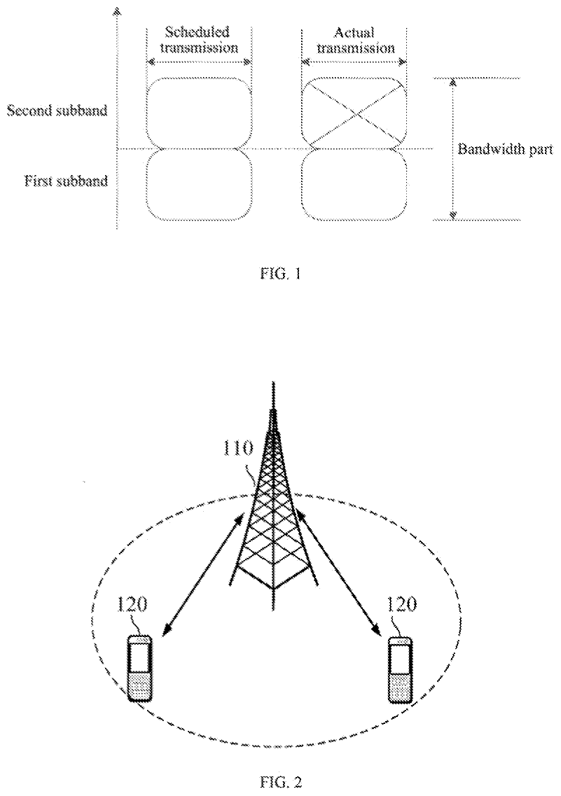

In 5G unlicensed spectrum, in a scenario of wideband transmission with a system carrier bandwidth greater than 20 MHz, a terminal device can be configured with a plurality of BWPs and only one BWP can be activated. When the activated BWP includes a plurality of LBT subbands, a network device can perform physical downlink shared channel (PDSCH) transmission through some or all of the LBT subbands included in the activated BWP according to channel listening results of the LBT subbands. FIG. 1 is a schematic diagram of a network device sending data to a terminal device through BWP0. As shown in FIG. 1, BWP0 configured by the network device to the terminal device includes two LBT subbands for a first subband and a second subband. The network device can transmit PDSCH to the terminal device by scheduling the first subband and the second subband. However, when the channel listening is performed on each of LBT subbands, the first subband LBT succeeds, that is, it is in an idle state, and the second subband LBT fails, that is, it is in a busy state. Therefore, the network device can transmit PDSCH to the terminal device through the first subband included in BWP0. In a situation that the network device transmits PDSCH through part of the subbands, how to effectively monitor quality of a downlink radio link is a problem that currently needs to be solved.

Therefore, the present solution proposes a radio link monitoring method, by determining a BWP to be monitored, and then by performing radio link monitoring on the BWP to be monitored according to target radio link monitoring-reference signal (RLM-RS) resource on at least one subband in the plurality of subbands of the BWP to be monitored, where the target RLM-RS resource is used to transmit the target RLM-RS. Because the radio link monitoring is performed on the BWP to be monitored according to the target RLM-RS resource on the at least one subband, an influence on a radio link monitoring result when the network device cannot send the reference signal through part of the subbands can be reduced, and the accuracy of radio link monitoring is improved.

The radio link monitoring method provided by the present disclosure is described below.

The technical solutions of the embodiments of the present disclosure can be applied to various communication systems, for example: global system of mobile communication (GSM) system, code division multiple access (CDMA) system, wideband code division multiple access (WCDMA) system, general packet radio service (GPRS) system, long term evolution (LTE) system, LTE frequency division duplex (FDD) system, LTE time division duplex (TDD) system, advanced long term evolution (LTE-A) system, new radio (NR) system, evolution system of a NR system, LTE-based access to unlicensed spectrum (LTE-U) system, NR-based access to unlicensed spectrum (NR-U) system, universal mobile telecommunication system (UMTS), worldwide interoperability for microwave access (WiMAX) communication system, wireless local area networks (WLAN), wireless fidelity (WiFi), and next generation communication system, 5G communication system, and future evolved communication systems or other communication systems, etc.

Generally speaking, traditional communication systems support a limited number of connections and are easy to implement. However, with the development of communication technology, mobile communication systems will not only support traditional communication, but also support, for example, device to device (D2D) communication, machine to machine (M2M) communication, machine type communication (MTC) and vehicle to vehicle (V2V) communication, etc. The embodiments of the present disclosure can also be applied to these communication systems.

Exemplarily, FIG. 2 is a schematic diagram of a communication system applied to an embodiment of the present disclosure. As shown in FIG. 2, the communication system may include a network device 110, and the network device 110 may be a device that communicates with a terminal device 120 (or referred to as a communication terminal or a terminal). The network device 110 may provide communication coverage for a specific geographic area, and may communicate with a terminal device located within the coverage area. In an embodiment, the network device 110 may be a base station (Base Transceiver Station, BTS) in a GSM system or a CDMA system, or a base station (NB) in a WCDMA system, or an evolutional base station (Evolutional Node B, eNB or eNodeB) in an LTE system, or a wireless controller in a cloud radio access network (CRAN), or the network device may be a mobile switching center, a relay station, an access point, an in-vehicle device, a wearable device, a hub, a switch, a network bridge, a router, a network-side device in a 5G network or a network device in a future evolved public land mobile network (PLMN), etc.

The communication system further includes at least one terminal 120 located within a coverage area of the network device 110. The “terminal” used herein includes, but is not limited to, a device that connects via a wired line, such as a connection via a public switched telephone networks (PSTN), a digital subscriber line (DSL), a digital cable, and a direct cable; and/or a device that connects via another data network; and/or a device that connects via a wireless interface, for example, via with respect to a cellular network, a wireless local area network (WLAN), a digital television network such as Digital Video Broadcasting Handheld (DVB-H) network, a satellite network, an Amplitude Modulation Frequency Modulation (AM-FM) broadcast transmitter; and/or via an apparatus that is configured to receive/send communication signals of another terminal device; and/or an Internet of Things (IoT) device. A terminal device that is configured to communicate through a wireless interface may be referred to as a “wireless communication terminal”, a “wireless terminal” or a “mobile terminal”. Examples of a mobile terminal include, but are not limited to, a satellite or a cellular phone; a personal communications system (PCS) terminal that can combine a cellular radio phone with data processing, fax, and data communication capability; a PDA that can include a radio phone, a pager, internet/Intranet access, a web browser, a notepad, a calendar, and/or a global positioning system (GPS) receiver; and a conventional laptop and/or palmtop receivers or others electronic apparatuses including radio telephone transceivers. The terminal device can refer to an access terminal, a user equipment (UE), a user unit, a user station, a mobile station, a mobile platform, a remote station, a remote terminal, a mobile device, a user terminal, a terminal, a wireless communication device, a user agent, or a user apparatus. The access terminal can be a cellular phone, a cordless phone, a session initiation protocol (SIP) phone, a wireless local loop (WLL) station, a personal digital assistant (PDA), a handheld device with wireless communication functions, a computing device or other processing devices connected to a wireless modem, an in-vehicle device, a wearable device, a terminal device in a 5G network or a terminal device in a future evolved PLMN, etc.

In an embodiment, a device to device (D2D) communication may be performed between the terminals 120.

In an embodiment, a 5G system or 5G network may also be referred as a new radio (NR) system or a NR network.

FIG. 2 exemplarily shows one network device and two terminal devices. In an embodiment, the communication system may include a plurality of network devices, and coverage of each network device may include other numbers of terminal devices, which is not limited in the embodiments of the present disclosure.

In an embodiment, the communication system may also include other network entities such as a network controller and a mobility management entity, etc., which is not limited in the embodiments of the present disclosure.

It should be understood that devices with communication functions in the network/system in the embodiments of the present disclosure may be referred to as communication devices. Taking the communication system shown in FIG. 2 as an example, the communication device may include the network device 110 and the terminal 120 with communication functions, and the network device 110 and the terminal 120 may be the specific devices described above, which will not be repeated herein. The communication device may further include other devices in the communication system, such as other network entities, for example a network controller and a mobility management entity, etc., which is not limited in the embodiments of the present disclosure

It should be understood that the terms “system” and “network” herein are often used interchangeably herein. The term “and/or” herein is merely an association relationship describing associated objects, and represents that there may be three relationships. For example, A and/or B may represent three situations: presence of A only, of both A and B, and of B only. In addition, the character “/” herein generally represents an “or” relationship between contextual objects.

The method of the embodiment of the present disclosure can be applied to communication of the unlicensed spectrum, and can also be applied to other communication scenarios, such as a communication scenario of a licensed spectrum.

The unlicensed spectrum is a spectrum that can be used for radio device communication divided by countries and regions. The spectrum can be considered as a shared spectrum, that is, communication devices in different communication systems can use the spectrum as long as they meet regulatory requirements set by countries or regions on the spectrum, and it is not necessary to apply for a proprietary spectrum grant from a government. In order to make each communication system using unlicensed spectrum for wireless communication coexist on the spectrum, communication device can follow the principle of listen before talk (LBT) when communicating on the unlicensed spectrum, that is, communication device needs to firstly perform channel listening (or called channel detection) before sending a signal on the channel of unlicensed spectrum. Only when a channel listening result is that the channel is idle, the communication device can send the signal; if the channel listening result of the communication device on the channel of the unlicensed spectrum is that the channel is busy, the signal cannot be sent. In an embodiment, a bandwidth of LBT is 20 MHz, or an integral multiple of 20 MHz.

The radio link monitoring method provided by the present disclosure includes: a terminal device determines a BWP to be monitored, and the BWP to be monitored includes a plurality of subbands, then the terminal device performs radio link monitoring on the BWP to be monitored according to a target RLM-RS resource on at least one subband in the plurality of subbands. Where, the target RLM-RS resource is used to transmit the target RLM-RS. Because the terminal device can monitor the BWP to be monitored according to the RLM-RS resource on at least one subband in the plurality of subbands, an influence on a radio link monitoring result when the network device cannot send the reference signal through part of the subbands can be reduced, and the accuracy of radio link monitoring is improved.

A specific implementation of performing radio link monitoring for BWP to be monitored by the terminal device according to RLM-RS resource on at least one subband in the plurality of subbands will be introduced below through several embodiments.

FIG. 3 is an implementation flow chart of a radio link monitoring method provided by the present disclosure, as shown in FIG. 3, the method includes some or all of the following steps:

S101: determining a BWP to be monitored, where the BWP to be monitored includes a plurality of subbands.

In this step, when a terminal device monitors a radio link, it firstly needs to determine a BWP to be monitored. Exemplarily, the BWP to be monitored may be an activated BWP of the terminal device on a special cell, or the BWP to be monitored may be an initial BWP of the terminal device on the special cell. Where, the special cell includes a primary cell of the terminal device, or the special cell can include a primary cell in a primary cell group of the terminal device, or the special cell includes a primary cell in a secondary cell group of the terminal device.

It should be noted that the initial BWP includes an initial downlink BWP, through which the terminal device can complete an initial access process.

In addition, the BWP to be monitored includes a plurality of subbands, which can be LBT subbands when a network device performs LBT. In other words, when the network device sends a reference signal to the terminal device through the LBT subbands, it needs to firstly listen to the state of the subbands. If the subbands are in the idle state, the network device can send the reference signal to the terminal device through the idle subbands. Of course, the subbands can also be subbands determined according to other methods, which is not limited in the present disclosure.

As an example and not a limitation, a size of the subband may be 20 MHz or an integral multiple of 20 MHz.

In an embodiment, the activated BWP of the terminal device in the special cell includes a plurality of subbands, and the initial BWP of the terminal device on the special cell includes one subband. Therefore, the terminal device determines that the BWP to be monitored on the special cell is the initial BWP. This is mainly because, when the activated BWP of the terminal device includes at least two subbands on a frequency domain, since the initial BWP only includes one subband, the radio link monitoring RLM can be restricted from being performed on the initial BWP, so as to reduce an influence on a RLM result when part of the subbands in the frequency domain cannot be transmitted during an RLM process.

S102: performing radio link monitoring on the BWP to be monitored according to a target RLM-RS resource on at least one subband in the plurality of subbands, where the target RLM-RS resource is used to transmit the target RLM-RS.

In this step, there may be subbands in the busy state in the plurality of subbands, so network devices will not be able to transmit RLM-RS through the target RLM-RS resources in these subbands in the busy state. In order to reduce an influence on monitoring results of the radio link monitoring when the network device cannot transmit RLM-RS through part of the subbands, the terminal device needs to determine at least one subband from the plurality of subbands, so that it can perform radio link monitoring on the BWP to be monitored according to the target RLM-RS resource on the at least one subband.

In an embodiment, the at least one subband among the above plurality of subbands may include a subband for transmitting the target RLM-RS among the plurality of subbands.

In an embodiment, in the embodiment of the present disclosure, performing radio link monitoring on the BWP to be monitored includes: evaluating whether downlink radio link quality estimated on the target RLM-RS resource is lower than an out-of-sync threshold within an out-of-sync evaluation period; and/or, evaluating whether the downlink radio link quality estimated on the target RLM-RS resource is higher than an in-sync threshold within an in-sync evaluation period. It should be noted that performing radio link monitoring on the BWP to be monitored can further include other evaluation indicators, for example evaluating whether the target RLM-RS on the target RLM-RS resource is transmitted, etc., which is not limited by the present disclosure.

As an example but not a limitation, in the present solution, the at least one subband includes a subband that actually transmits the target RLM-RS in the plurality of subbands within one evaluation period. Where, because the target RLM-RS resource can appear periodically, the target RLM-RS resource may appear many times within an evaluation period. Therefore, for each target RLM-RS resource, it is necessary to independently judge whether the network device transmits the target RLM-RS through the target RLM-RS resource.

It should be understood that an evaluation period can be an in-sync evaluation period, an out-of-sync evaluation period, or an evaluation period of other indicators, which is not limited by the present disclosure.

It should be understood that the solution in the embodiment of the present disclosure is described for one target RLM-RS resource. In practical disclosure, the terminal device may be configured with one or a plurality of target RLM-RS resources for performing downlink radio link quality evaluation. When the terminal device is configured with the plurality of target RLM-RS resources for performing downlink radio link quality evaluation, the solution in the present disclosure can be adopted for each target RLM-RS resource.

In an embodiment, when the terminal device is configured with the plurality of target RLM-RS resources for performing downlink radio link quality evaluation, different target RLM-RS resources can correspond to different beam directions.

In an embodiment, when the terminal device is configured with the plurality of target RLM-RS resources for performing downlink radio link quality evaluation, different target RLM-RS resources can correspond to a same beam direction.

In an embodiment, at least one of the above plurality of subbands may include a first subband, which is a subband with a smallest index value among subbands transmitting the target RLM-RS in the plurality of subbands.

As an example but not a limitation, in the present solution, the first subband is the subband with the smallest index value among the subbands that actually transmit the target RLM-RS in the plurality of subbands within one evaluation period. For example, the BWP0 to be monitored activated by terminal device includes four subbands, which are subband 0, subband 1, subband 2 and subband 3 respectively. The target RLM-RS resource configured by the network device for BWP0 is located on each of the four subbands. Within one evaluation period, if the network device only obtains a channel usage right of part of the subbands, that is to say, the network device can only send the target RLM-RS to the terminal device through part of the subbands. It is supposed that the network device sends the target RLM-RS to the terminal device through the target RLM-RS resources on subband 0, subband 1 and subband 2, then the first subband is subband 0. Another example: the BWP0 to be monitored activated by the terminal device includes four subbands, which are subband 0, subband 1, subband 2 and subband 3 respectively. The target RLM-RS resource configured by the network device for BWP0 is located on each of the four subbands. Within one evaluation period, the target RLM-RS resource appears S times on a time domain. Where within one evaluation period, at the ith (i=0, 1, 2, . . . , S−1) occurrence time of the target RLM-RS resource, if the network device only obtains the channel usage right of part of the subbands, then the network device can only send the target RLM-RS to the terminal device through part of the subbands at this time. It is supposed that at this time, the network device sends the target RLM-RS to the terminal device through the target RLM-RS resources on subband 0, subband 1 and subband 2, then the first subband is subband 0 at this time. In other words, each occurrence time of the target RLM-RS resource can correspond to one first subband. Within one evaluation period, a first subband corresponding to different times can be different.

In an embodiment, at least one of the above plurality of subbands may include a second subband, which is a subband with a largest index value among subbands transmitting the target RLM-RS in the plurality of subbands.

As an example but not a limitation, in the present solution, the second subband is the subband with the largest index value among the subbands that actually transmit the target RLM-RS in the plurality subbands within one evaluation period. For example, the BWP0 to be monitored activated by terminal device includes four subbands, which are subband 0, subband 1, subband 2 and subband 3 respectively. The target RLM-RS resource configured by network devices for BWP0 is located on each of the four subbands. Within one evaluation period, if the network device only obtains the channel usage right of part of the subbands, that is to say, the network device can only send the target RLM-RS to the terminal device through part of the subbands. It is supposed that the network device sends the target RLM-RS to the terminal device through the target RLM-RS resources on subband 0, subband 1 and subband 2, then the second subband is subband 2. Another example: the BWP0 to be monitored activated by the terminal device includes four subbands, which are subband 0, subband 1, subband 2 and subband 3 respectively. The target RLM-RS resource configured by network device for BWP0 is located on each of the four subbands. Within one evaluation period, the target RLM-RS resource appears S times on the time domain. Where within one evaluation period, at the ith (i=0, 1, 2, . . . , S−1) occurrence time of the target RLM-RS resource, if the network device only obtains the channel usage right of part of the subbands, then the network device can only send the target RLM-RS to the terminal device through part of the subbands at this time. It is supposed that at this time, the network device sends the target RLM-RS to the terminal device through the target RLM-RS resources on subband 0, subband 1 and subband 2, then the second subband is subband 2 at this time. In other words, each occurrence time of the target RLM-RS resource can correspond to one second subband. Within one evaluation period, a second subband corresponding to different times can be different.

In addition, the network device and the terminal device can use the means of negotiation or agreement, for example, the network device sends instruction information to the terminal device to inform the terminal device whether to send the target RLM-RS on the first subband or the second subband.

In an embodiment, the terminal device determines a subband transmitting the target RLM-RS in the plurality of subbands, or the terminal device determines RLM-RS resource transmitting the target RLM-RS in the plurality of subbands, specifically including the following two manners:

in a first manner, the subband transmitting the target RLM-RS in the plurality of subbands is determined by the terminal device according to the instruction information sent by the network device, which is used to determine the subband that actually transmits the target RLM-RS in the plurality of subbands.

The subband that actually transmits the target RLM-RS in the plurality of subbands can be a subband that RLM-RS resource is allocated for and transmits the target RLM-RS on the allocated RLM-RS resource in the plurality of subbands.

As an example but not a limitation, after the network device determines the subband that may transmit signal in the plurality of subbands by means of listening, it can send instruction information to the terminal device, where the instruction information is used to instruct a subband that actually performs signal transmission in the plurality of subbands. For the terminal device, it receives the instruction information sent by the network device, and according to the instruction information, it can determine the subband that actually performs signal transmission of the network device within a period of time. If the RLM-RS resource belongs to the period of time, then the terminal device can determine at least one subband that actually performs target RLM-RS transmission from the plurality of subbands.

For example, if the BWP to be monitored includes subband 0, subband 1, subband 2 and subband 3, and if the network device determines that subband 0, subband 1 and subband 2 are in the idle state after listening, then the network device will send instruction information to the terminal device, so that the terminal device can determine that subband 0, subband 1 and subband 2 are subbands that actually perform signal transmission within a first time period through the instruction information. If the target RLM-RS resources configured by the network device on subband 0, subband 1 and subband 2 are within the first time period, then the network device can transmit the target RLM-RS through subband 0, subband 1 and subband 2, and the terminal device can determine that subband 0, subband 1 and subband 2 are the subbands that actually perform target RLM-RS transmissions in the plurality of subbands.

In a second manner, the subband transmitting the target RLM-RS in the plurality of subbands is determined by a terminal device according to a manner of blind detection of a reference signal.

As an example but not a limitation, the terminal device receives the reference signal through the target RLM-RS resources on the plurality of subbands, and determines the subband transmitting the target RLM-RS from the plurality of subbands according to a receiving result.

In a specific implementation of the solution, for each subband in the plurality of subbands, the receiving result can include that the terminal device has received the reference signal on a certain subband, or the terminal device has not received the reference signal on the subband. If the terminal device receives the reference signal on a certain subband, it can determine that the subband is the subband transmitting the target RLM-RS, otherwise, the subband is a subband not transmitting the target RLM-RS. Based on this, the terminal device will be able to determine the subband transmitting the target RLM-RS from the plurality of subbands by the means of blind detection of the reference signal (or in other words, detection of existence of the reference signal).

Specifically, as an example, the network device can configure a RLM-RS resource for the BWP to be monitored, where at least one subband existed in the BWP to be monitored is configured with the RLM-RS resource. For each subband, the terminal device receives the reference signal through the target RLM-RS resource on the subband, and detects a correlation peak between the received reference signal and a local preset reference signal sequence. If a detection result is greater than a preset threshold, then the terminal device determines that the reference signal is received on the subband, otherwise, the terminal device considers that the reference signal is not received on the subband.

Exemplarily, the above reference signal may be the target RLM-RS. Of course, it can also be other reference signals, for example, it can be a demodulation reference signal DMRS). A specific form of the reference signal is not limited in the embodiment of the present disclosure.

As an example but not a limitation, the terminal device receives the DMRS for demodulating a PDCCH sent by the network device, and can determine the subband that actually performs signal transmission by the network device within a period of time according to the blind detection of the DMRS of the PDCCH. If RLM-RS resource belongs to the period of time, then the terminal device can determine at least one subband that actually performs target RLM-RS transmission from the plurality of subbands.

It can be understood that in the above solution, the target RLM-RS resource includes RLM-RS resource transmitting the target RLM-RS.

It should be understood that in the embodiment of the present disclosure, the subband that actually performs signal transmission of the network device within the period of time may include: a subband occupied by the network device within the period of time. The RLM-RS resource transmitting the target RLM-RS may include: RLM-RS resource on a subband and a symbol occupied by the network device in the target RLM-RS resource. The RLM-RS resource not transmitting the target RLM-RS may include: RLM-RS resource on a subband or a symbol not occupied by the network device in the target RLM-RS resource. Resource that the network device obtains the channel usage right may include: resource on a subband and a symbol occupied by the network device. Resource that the network device does not obtain the channel usage right may include: resource on a subband or a symbol not occupied by the network device.

Specifically, no matter whether at least one subband includes the subband transmitting the target RLM-RS in the plurality of subbands, or includes the first subband, or includes the second subband, the at least one subband is the subband that actually transmits the target RLM-RS. Therefore, the target RLM-RS resource on the at least one subband includes the RLM-RS resource that actually transmits the target RLM-RS.

In an embodiment, at least one subband within the above plurality of subbands may include each of the plurality of subbands.

Specifically, the at least one subband may include each of the plurality of subbands. In this solution, the terminal device will perform radio link monitoring on the BWP to be monitored according to the target RLM-RS resource on each subband.

In an embodiment, at least one of the above plurality of subbands may include a third subband, which is a subband preset in the plurality of subbands.

Specifically, the at least one subband may be a subband preset in a plurality of subbands. Exemplarily, the third subband may be a subband including a same frequency domain resource as an initial BWP, or may be a subband with a smallest index value in the plurality of subbands, or may further be a subband with a largest index value in the plurality of subbands. For example, the BWP to be monitored of the terminal device includes subband 0, subband 1, subband 2 and subband 3, and the initial BWP of the terminal device includes subband 2, then the third subband is subband 2.

It can be understood that when the at least one subband includes each of the plurality of subbands, or the at least one subband includes the third subband, the target RLM-RS resource includes the RLM-RS resource transmitting the target RLM-RS, and/or the target RLM-RS resource includes the RLM-RS resource not transmitting the target RLM-RS.

For example, when the at least one subband includes each of the plurality of subbands, if each subband is in the idle state and the network device transmits the target RLM-RS through the target RLM-RS resource on each subband, at this time, the target RLM-RS resource on the at least one subband is the RLM-RS resource transmitting the target RLM-RS. For another example, if there are part of the subbands in the idle state and part of the subbands in the busy state, and the network device transmits the target RLM-RS through the target RLM-RS resource on the subband in the idle state, at this time, the target RLM-RS resource on the at least one subband includes the RLM-RS resource transmitting the target RLM-RS on the subband in the idle state, and/or, RLM-RS resource not transmitting the target RLM-RS on the subband in the busy state. For another example, if each subband is in the busy state and the network device does not transmit the target RLM-RS through the target RLM-RS resource on any one of subbands, then at this time the target RLM-RS resource on at the least one subband includes the RLM-RS resource not transmitting the target RLM-RS.

In addition, when at least one subband includes a third subband preset in the plurality of subbands, if the third subband is in the idle state and the network device transmits the target RLM-RS through the target RLM-RS resource on the third subband, at this time, the target RLM-RS resource on the at least one subband is the RLM-RS resource transmitting the target RLM-RS. If there are part of the third subband in the idle state and part of the third subband in the busy state, and the network device transmits the target RLM-RS through the target RLM-RS resource on the third subband in the idle state, at this time, the target RLM-RS resource on the at least one subband includes the RLM-RS resource transmitting the target RLM-RS on the third subband in the idle state, and/or, RLM-RS resource not transmitting the target RLM-RS on the third subband in the busy state. If the third subband is in the busy state and the network device does not transmit the target RLM-RS through the target RLM-RS resource on any one of the third subband, at this time the target RLM-RS resource on at the least one subband includes the RLM-RS resource not transmitting the target RLM-RS.

In one possible implementation, the terminal device can determine whether the target RLM-RS resource is the RLM-RS resource transmitting the target RLM-RS or the RLM-RS resource not transmitting the target RLM-RS according to the blind detection of the target RLM-RS on the target RLM-RS resource.

Specifically, the terminal device receives the target RLM-RS through the target RLM-RS resource on the at least one subband. If the target RLM-RS is received on a certain target RLM-RS resource, the target RLM-RS resource can be determined as the RLM-RS resource transmitting the target RLM-RS. If the target RLM-RS resource is not received on a certain target RLM-RS resource, the target RLM-RS resource can be determined as the RLM-RS resource not transmitting the target RLM-RS.

In an embodiment, the terminal device performs radio link monitoring on the BWP to be monitored according to a target RLM-RS resource on at least one subband in the plurality of subbands, which can be perform radio link monitoring on the BWP to be monitored according to the target RLM-RS resource on one subband in the plurality of subbands or can also be perform radio link monitoring on the BWP to be monitored according to the target RLM-RS resources on at least two subbands in the plurality of subbands. Of course, it can further be perform radio link monitoring on the BWP to be monitored according to target RLM-RS resource on each subband in the plurality of subbands.

The performing radio link monitoring on the BWP to be monitored according to a target RLM-RS resource on at least one subband in the plurality of subbands may include the following process: evaluating whether downlink radio link quality estimated on the target RLM-RS resource on at least one subband is lower than an out-of-sync threshold within an out-of-sync evaluation period; and/or, evaluating whether the downlink radio link quality estimated on the target RLM-RS resource on at least one subband is higher than an in-sync threshold within an in-sync evaluation period.

Where, the terminal device may only evaluate whether the downlink radio link quality estimated on the target RLM-RS resource on at least one subband is lower than the out-of-sync threshold within the out-of-sync evaluation period, or may only evaluate whether the downlink radio link quality estimated on the target RLM-RS resource on at least one subband is higher than the in-sync threshold within the in-sync evaluation period, and further evaluate whether the downlink radio link quality estimated on the target RLM-RS resource on at least one subband is lower than the out-of-sync threshold within the out-of-sync evaluation period, as well as evaluate whether the downlink radio link quality estimated on the target RLM-RS resource on at least one subband is higher than the in-sync threshold within the in-sync evaluation period.

In an embodiment, the in-sync threshold and the out-of-sync threshold correspond to different block error rates (BLER) values respectively. In an embodiment, the BLER value corresponding to the in-sync threshold or out-of-sync threshold is configured by the network device. In an embodiment, the in-sync threshold or out-of-sync threshold is obtained under an assumption of certain PDCCH transmission parameters. In an embodiment, under the assumption of certain PDCCH transmission parameters, BLER value and SINR value corresponding to the in-sync threshold can be obtained. In an embodiment, under the assumption of certain PDCCH transmission parameters, BLER value and SINR value corresponding to the out-of-sync threshold can be obtained.

In an embodiment, when the RLM-RS resource includes different reference signals (RS), the in-sync thresholds or out-of-sync thresholds corresponding to different RSs are determined independently. For example, when RLM-RS resource includes CSI-RS resource, the CSI-RS resource corresponds to a first in-sync threshold or a first out-of-sync threshold; when RLM-RS resource includes SSB resource, the SSB resource corresponds to a second in-sync threshold or a second out-of-sync threshold.

In an embodiment, when the at least one subband includes the subband transmitting the target RLM-RS in the plurality of subbands, the terminal device can estimate whether the downlink radio link quality is lower than the out-of-sync threshold according to the target RLM-RS resources on all the subbands that have transmitted the target RLM-RS within the out-of-sync evaluation period, so as to perform the radio link monitoring on the BWP to be monitored. Where, the terminal device can receive the target RLM-RS through the target RLM-RS resource on the at least one subband to estimate the downlink radio link quality.

As an example but not a limitation, the terminal device performing the radio link monitoring on the BWP to be monitored within an evaluation period may include the following implementation. It is assumed that within the evaluation period, the target RLM-RS resource for monitoring the radio link quality includes target RLM-RS resource configured to appear at least once on each subband in the at least one subband, where the target RLM-RS resource includes the RLM-RS resource transmitting the target RLM-RS and/or the RLM-RS resource not transmitting the target RLM-RS.

As an example but not a limitation, the terminal device obtains a corresponding signal to interference plus noise ratio (SINR) according the target RLM-RS resource for monitoring the radio link quality that appears at least once on each subband in the at least one subband, and according to the SINR and a preset out-of-sync threshold, determines whether a block error rate (BLER) corresponding to a signal transmitted on the target RLM-RS resource is lower than the out-of-sync threshold, or according to the SINR and a preset in-sync threshold, determines whether the BLER corresponding to the signal transmitted on the target RLM-RS resource is higher than the in-sync threshold, so as to determine the radio link quality corresponding to the target RLM-RS resource, and then determine the radio link monitoring result of the whole BWP to be monitored. Exemplarily, it can determine a SINR corresponding to the preset out-of-sync threshold, and determine whether a SINR corresponding to the target RLM-RS resource (or the signal transmitted on the target RLM-RS resource) is greater than the SINR corresponding to the out-of-sync threshold. If the SINR corresponding to the target RLM-RS resource is higher than the SINR corresponding to the out-of-sync threshold, it can be determined that a BLER corresponding to the target RLM-RS resource is lower than the out-of-sync threshold. On the contrary, if the SINR corresponding to the target RLM-RS resource is lower than the SINR corresponding to the out-of-sync threshold, it can be determined that the BLER corresponding to the target RLM-RS resource is higher than the out-of-sync threshold. It can also determine a SINR corresponding to the preset in-sync threshold, and determine whether a SINR corresponding to the target RLM-RS resource is lower than the SINR corresponding to the in-sync threshold. If the SINR corresponding to the target RLM-RS resource is lower than the SINR corresponding to the in-sync threshold, it can be determined that a BLER corresponding to the target RLM-RS resource is higher than the in-sync threshold. On the contrary, if the SINR corresponding to the target RLM-RS resource is higher than the SINR corresponding to the in-sync threshold, it can be determined that the BLER corresponding to the target RLM-RS resource is lower than the in-sync threshold.

Where, the evaluation period can be an out-of-sync evaluation period or an in-sync evaluation period, and can also be an evaluation period of other indicators.

As an example but not a limitation, the terminal device evaluating the radio link quality within the evaluation period may include at least one of the following four cases. Similarly, it is assumed that within the evaluation period, the target RLM-RS resource for monitoring the radio link quality includes a target RLM-RS resource configured to appear at least once on each subband in the at least one subband, where the target RLM-RS resource includes the RLM-RS resource transmitting the target RLM-RS and/or the RLM-RS resource not transmitting the target RLM-RS.

In a first case, within each evaluation period, in the target RLM-RS resource configured to appear at least once on each subband in the at least one subband, the target RLM-RS resource appearing each time may correspond to one SINR, and one judgment result can be obtained according to the one SINR. Therefore, within each evaluation period, the target RLM-RS resource appearing each time corresponds to one judgment result.

In a second case, within each evaluation period, the target RLM-RS resource configured to appear at least once on each subband in the at least one subband may correspond to one SINR (for example, performing the averaging or filtering on the signal detection on the target RLM-RS resource appearing a plurality of times), that is, each subband in the at least one subband corresponds to one SINR, and one judgment result can be obtained according to the one SINR. Therefore, within each evaluation period, the target RLM-RS resource on each subband corresponds to one judgment result.

In a third case, within each evaluation period, the target RLM-RS resource is configured to appear S times on each subband in the at least one subband. For the time when the target RLM-RS resource appears each time, the at least one subband can correspond to one SINR (for example, performing the averaging or filtering on the signal detection on the target RLM-RS resource on each subband in the at least one subband), and one judgment result can be obtained according to the one SINR. Therefore, within each evaluation period, the time when the target RLM-RS resource appears each time corresponds to one judgment result, and S judgment results are included within the evaluation period.

In a fourth case, within each evaluation period, all the target RLM-RS resources in the at least one subband can correspond to one SINR (for example, performing the averaging or filtering on the signal detection on the target RLM-RS resource appearing a plurality of times in each subband), and each RLM-RS resource corresponds to one SINR, and one judgment result can be obtained according to the one SINR. Therefore, one judgment result is included within the evaluation period.

In an embodiment, in the above process of performing the averaging or filtering on the signal detection on the target RLM-RS resource appearing the plurality of times, performing the averaging or filtering on the signal detection on the plurality of RLM-RS resources transmitting the target RLM-RS, and/or performing the averaging or filtering on the signal detection on the plurality of RLM-RS resources not transmitting the target RLM-RS. In an embodiment, the terminal device does not perform the averaging or filtering on the signal detection on the RLM-RS resource transmitting the target RLM-RS and the RLM-RS resource not transmitting the target RLM-RS.

It should be understood that in the above several cases, the judgment result includes: within the out-of-sync evaluation period, evaluating whether the downlink radio link quality estimated on the target RLM-RS resource on at least one subband is lower than the out-of-sync threshold; or, within the in-sync evaluation period, evaluating whether the downlink radio link quality estimated on the target RLM-RS resource on at least one subband is higher than the in-sync threshold.

It should be explained that in the above solution, for each target RLM-RS resource, it will judge whether the estimated downlink radio link quality is lower than the out-of-sync threshold. Within a whole out-of-sync evaluation period, there may be a plurality of judgment results of a plurality of target RLM-RS resources or a plurality of judgment results of one target RLM-RS resource (for example, the above first case, the above second case, and the above third case). In an embodiment, within the out-of-sync evaluation period, when all the judgment results are that the quality of the downlink radio link is lower than the out-of-sync threshold, a physical layer of the terminal device will report an out-of-sync instruction to a high layer.

It should be explained that in the above solution, for each target RLM-RS resource, it will judge whether the estimated downlink radio link quality is higher than the in-sync threshold. Within the whole in-sync evaluation period, there may be a plurality of judgment results of a plurality of target RLM-RS resources, or a plurality of judgment results of one target RLM-RS resource (for example, the above first case, the above second case, and the above third case). In an embodiment, within the in-sync evaluation period, as long as there is a judgment result that the quality of the downlink radio link is higher than the in-sync threshold, the physical layer of the terminal device will report the in-sync instruction to the high layer.

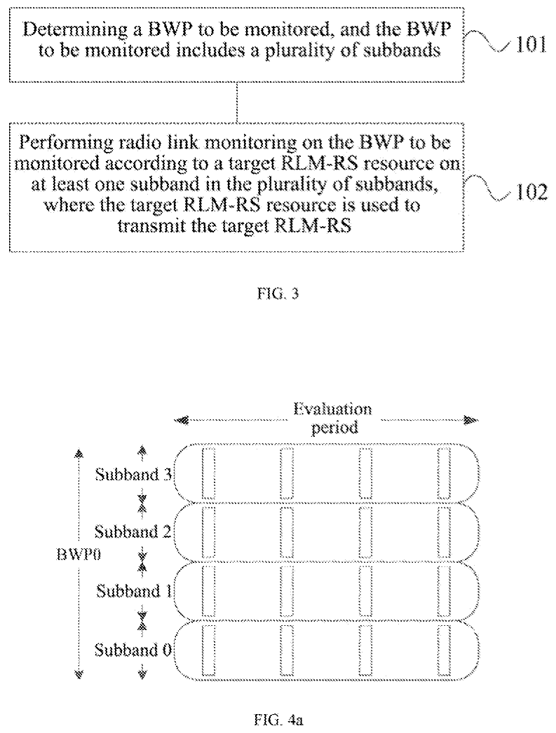

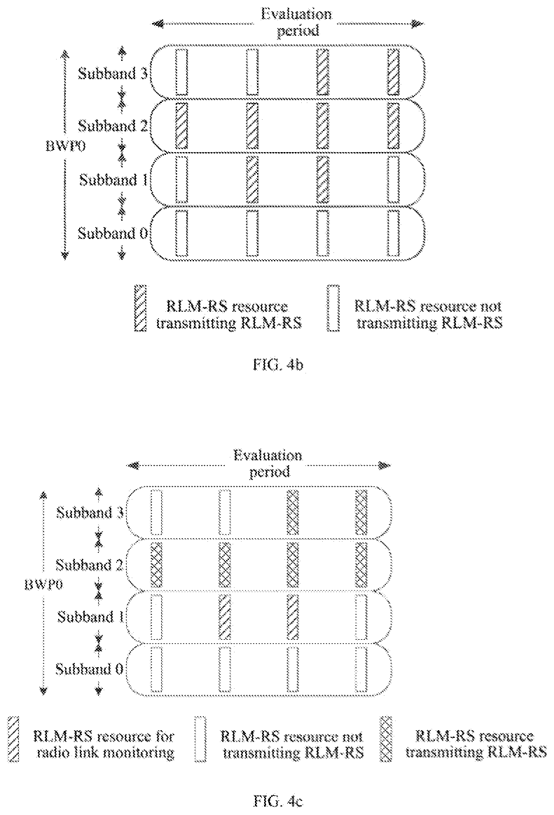

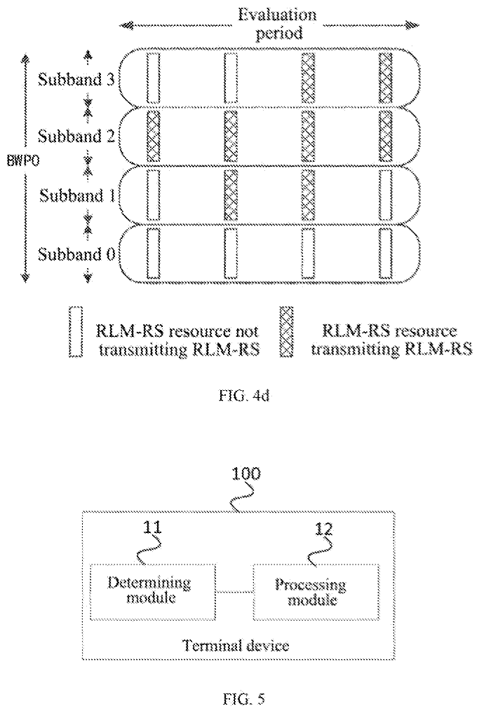

For example, FIG. 4a is a schematic diagram of subbands and target RLM-RS resource configurations in a BWP, and FIG. 4b is a schematic diagram of subbands for transmitting a target RLM-RS. As shown in FIG. 4a, the BWP0 to be monitored activated by the terminal device includes four subbands, which are subband 0, subband 1, subband 2 and subband 3 respectively. The RLM-RS resource configured by the network device for BWP of the terminal device is located in each of the four subbands. As shown in FIG. 4b, within the evaluation period, if the network device only obtains a channel usage right of part of the subbands, that is to say, the network device can only send the target RLM-RS to the terminal device through part of the subbands. Therefore, the network device will only send the target RLM-RS on part of the configured RLM-RS resource. The terminal device will estimate the downlink radio link quality according to the target RLM-RS resource on the subband transmitting the target RLM-RS. For example, the network device only sends the target RLM-RS on the target RLM-RS resources configured on subband 1, subband 2 and subband 3, then the terminal device will also estimate the downlink radio link quality according to the target RLM-RS resources configured on subband 1, subband 2 and subband 3. Or, the terminal device will estimate the downlink radio link quality according to the target RLM-RS resource transmitting the target RLM-RS. For example, the terminal device will estimate the downlink radio link quality according to RLM-RS resources appearing for 1st and 2nd time (counting from 0) on subband 1, a RLM-RS resource on subband 2, and RLM-RS resources appearing for the 2nd and 3rd time on subband 3.

Where, if the evaluation period is an out-of-sync evaluation period, the terminal device can evaluate whether the downlink radio link quality is lower than the out-of-sync threshold according to the above target RLM-RS resource, or if the evaluation period is an in-sync evaluation period, the terminal device can evaluate whether the downlink radio link quality is higher than the in-sync threshold according to the above target RLM-RS resource.

Exemplarily, a BLER corresponding to the above out-of-sync threshold is 10%, and a BLER corresponding to the in-sync threshold can be 2%.

In the above solution, the terminal device estimates the downlink radio link quality according to the target RLM-RS resource on the subband actually transmitting the target RLM-RS in the plurality of subbands or according to the target RLM-RS resource actually transmitting the target RLM-RS in the plurality of subbands, and judges whether the downlink radio link quality is lower than the out-of-sync threshold or is higher than the in-sync threshold. Thus, performing the radio link monitoring on the BWP to be monitored can reduce an influence on a radio link monitoring result when the network device cannot send the target RLM-RS through part of the subbands in the BWP, so as to improve an accuracy of radio link monitoring.

In an implementation, the terminal device can perform the radio link monitoring on the BWP to be monitored through the target RLM-RS resource on the first subband, the second subband or the third subband. For example, the terminal device can receive the target RLM-RS through the target RLM-RS resource on the first subband, the second subband or the third subband, and obtain a SINR corresponding to the target RLM-RS on the first subband, the second subband or the third subband, and determine radio link quality corresponding to the first subband, the second subband or the third subband according to the SINR corresponding to the target RLM-RS on the first subband, the second subband or the third subband and a preset evaluation threshold, so as to perform the radio link monitoring on the BWP to be monitored.

For example, FIG. 4c is another schematic diagram of subbands transmitting a target RLM-RS. As shown in FIG. 4c, the BWP0 to be monitored activated by the terminal device includes four subbands, which are subband 0, subband 1, subband 2 and subband 3 respectively. The RLM-RS resource configured by the network device for BWP0 of the terminal device is located on each subband in the four subbands. Within the evaluation period, if the network device only obtains a channel usage right of part of the subbands, that is to say, the network device can only send the reference signal to the terminal device through part of the subbands. Therefore, the network device will only send the target RLM-RS on part of the configured RLM-RS resource. For example, the case that the network device sends the target RLM-RS to the terminal device is shown in FIG. 4b. As an example, the terminal device can estimate the downlink radio link quality according to the target RLM-RS resource on the first subband, where the first subband is a subband with a smallest index value among subbands transmitting the target RLM-RS in the plurality of subbands, as shown in FIG. 4c. In an embodiment, the terminal device can also estimate the downlink radio link quality according to the target RLM-RS resource on the second subband or the third subband, where the second subband is a subband with a largest index value among the subbands transmitting the target RLM-RS in the plurality of subbands, and the third subband is a subband preset in the plurality of subbands.

Alternatively, the first subband, the second subband, or the third subband is determined according to the RLM-RS resource appearing each time within the evaluation period. For example, in FIG. 4c, a first subband corresponding to the RLM-RS resource that appears for a 0th time within the evaluation period is subband 2, a first subband corresponding to the RLM-RS resource that appears for a 1st time is subband 1, a first subband corresponding to the RLM-RS resource that appears for a 2nd time is subband 1, and a first subband corresponding to the RLM-RS resource that appears for a 3rd time is subband 2. Accordingly, the terminal device can estimate the downlink radio link quality according to the RLM-RS resources that appear for the 0th and 3rd time on subband 2 and the RLM-RS resources that appear for the 1st and 2nd time on X) subband 1.

Where, if the evaluation period is an out-of-sync evaluation period, the terminal device can evaluate whether the downlink radio link quality is lower than the out-of-sync threshold according to the above target RLM-RS resource, or if the evaluation period is an in-sync evaluation period, the terminal device can evaluate whether the downlink radio link quality is higher than the in-sync threshold according to the above target RLM-RS resource.

Exemplarily, a BLER corresponding to the above out-of-sync threshold is 10%, and a BLER corresponding to the in-sync threshold can be 2%.

In the above solution, the terminal device estimates whether the downlink radio link quality is lower than the out-of-sync threshold or is higher than the in-sync threshold according to the target RLM-RS resource on the first subband, the second subband or the third subband, and then performing the radio link monitoring on the BWP to be monitored can reduce the influence on the radio link monitoring result when the network device cannot send the target RLM-RS through part of the subbands in the BWP, so as to improve the accuracy of radio link monitoring.

In an embodiment, the terminal device performing radio link monitoring on the BWP to be monitored according to a target RLM-RS resource on at least one subband in the plurality of subbands can further be perform monitoring on each subband independently. In the present solution, for one subband (for example, each subband) in at least one subband, evaluating whether downlink radio link quality on each subband estimated on the target RLM-RS resource on each subband is lower than an out-of-sync threshold within an out-of-sync evaluation period; and/or, for one subband (for example, each subband) in at least one subband, evaluating whether downlink radio link quality on each subband estimated on the target RLM-RS resource on each subband is higher than an in-sync threshold within an in-sync evaluation period.

Where, for each subband in at least one subband, the terminal device may only evaluate whether the downlink radio link quality on each subband estimated on the target RLM-RS resource on each subband is lower than an out-of-sync threshold within an out-of-sync evaluation period, or may only evaluate whether the downlink radio link quality on each subband estimated on the target RLM-RS resource on each subband is higher than an in-sync threshold within an in-sync evaluation period, and further evaluate whether the downlink radio link quality on each subband estimated on the target RLM-RS resource on each subband is lower than the out-of-sync threshold within the out-of-sync evaluation period, as well as evaluate whether the downlink radio link quality on each subband estimated on the target RLM-RS resource on each subband is higher than the in-sync threshold within the in-sync evaluation period.

As an example but not a limitation, the terminal device evaluates a radio link quality within the evaluation period, which may include at least one of the following two cases. Similarly, it is assumed that within the evaluation period, the target RLM-RS resource for monitoring the radio link quality includes a target RLM-RS resource configured to appear at least once on each subband in the at least one subband, where the target RLM-RS resource includes the RLM-RS resource transmitting the target RLM-RS and/or the RLM-RS resource not transmitting the target RLM-RS.

In a first case, within each evaluation period, in the target RLM-RS resource configured to appear at least once on each subband in the at least one subband, the target RLM-RS resource appearing each time may correspond to one SINR, and one judgment result can be obtained according to the one SINR. Therefore, within each evaluation period, the target RLM-RS resource appearing each time corresponds to one judgment result.

In a second case, within each evaluation period, the target RLM-RS resource configured to appear at least once on each subband in the at least one subband may correspond to one SINR (for example, performing the averaging or filtering on the signal detection on the target RLM-RS resource appearing a plurality of times), that is, each subband in the at least one subband corresponds to one SINR, and one judgment result can be obtained according to the one SINR. Therefore, within each evaluation period, the target RLM-RS resource on each subband corresponds to one judgment result.

In an embodiment, in the above process of performing the averaging or filtering on the signal detection on the target RLM-RS resource appearing the plurality of times, performing the averaging or filtering on the signal detection on the plurality of RLM-RS resources transmitting the target RLM-RS, and/or performing the averaging or filtering on the signal detection on the plurality of RLM-RS resources not transmitting the target RLM-RS. In an embodiment, the terminal device does not perform the averaging or filtering on the signal detection on the RLM-RS resource transmitting the target RLM-RS and the RLM-RS resource not transmitting the target RLM-RS.

It should be understood that in the above two cases, the judgment result includes: within the out-of-sync evaluation period, evaluating whether the downlink radio link quality estimated on the target RLM-RS resource on one subband in at least one subband is lower than the out-of-sync threshold; or, within the in-sync evaluation period, evaluating whether the downlink radio link quality estimated on the target RLM-RS resource on one subband in at least one subband is higher than the in-sync threshold.

It should be explained that in the above solution, for each target RLM-RS resource, it will judge whether the estimated downlink radio link quality is lower than the out-of-sync threshold. On one subband in the at least one subband within a whole out-of-sync evaluation period, there may be a plurality of judgment results of a plurality of target RLM-RS resources or a plurality of judgment results of one target RLM-RS resource (for example, the above first case). In an embodiment, On a certain subband in the at least one subband within the out-of-sync evaluation period, when all the judgment results are that the quality of the downlink radio link is lower than the out-of-sync threshold, a physical layer of the terminal device will report an out-of-sync instruction of the subband to a high layer.

It should be explained that in the above solution, for each target RLM-RS resource, it will judge whether the estimated downlink radio link quality is higher than the in-sync threshold. On one subband in the at least one subband within the whole in-sync evaluation period, there may be a plurality of judgment results of a plurality of target RLM-RS resources, or a plurality of judgment results of one target RLM-RS resource (for example, the above first case). In an embodiment, on a certain subband in the at least one subband within the in-sync evaluation period, as long as there is a judgment result that the downlink radio link quality is higher than the in-sync threshold, the physical layer of the terminal device will report the in-sync instruction of the subband to the high layer.

In an embodiment, in the present solution, the terminal device will receive the target RLM-RS through the target RLM-RS resource on each subband of the plurality of subbands. If the target RLM-RS is received on a certain subband, the downlink radio link quality on the subband will be determined according to the received target RLM-RS. For example, it can determine that whether a BLER corresponding to the target RLM-RS is lower than the out-of-sync threshold by a corresponding SINR determined by the received target RLM-RS and the preset out-of-sync threshold, or it can determine that whether a BLER corresponding to the target RLM-RS is higher than the in-sync threshold by a corresponding SINR determined by the received target RLM-RS and the preset in-sync threshold. In an embodiment, if the target RLM-RS is not received in a certain subband within a certain period of time, or the uplink (UL) channel detection (for example LBT) on a certain subband continues to fail, that is, the subband is the busy state, the terminal device can determine that the subband is in the radio link failure (RLF) state. In other words, the physical layer of the terminal device will report an out-of-sync instruction corresponding to the subband to the high layer of the terminal device.

In an embodiment, each subband can be monitored independently, and each subband can be monitored according to whether the target RLM-RS is received on each subband as a monitoring indicator. After determining that the target RLM-RS can be received, further according to a SINR corresponding to the target RLM-RS and the preset out-of-sync threshold or in-sync threshold to determine whether the BLER corresponding to the target RLM-RS is lower than the out-of-sync threshold, or is M4 higher than the in-sync threshold, so as to obtain the monitoring result of the subband.

For example, FIG. 4d is another schematic diagram of subbands. As shown in FIG. 4d, the BWP0 to be monitored activated by a terminal device includes four subbands, which are subband 0, subband 1, subband 2 and subband 3 respectively. The subband that the network device can transmit the target RLM-RS includes subband 1, subband 2 and subband 3. The network device sends the target RLM-RS through the target RLM-RS resources on subband 1, subband 2 and subband 3 that have obtained the channel usage right. Correspondingly, the terminal device receives the target RLM-RS on the four subbands. Within a preset time period, if the terminal device can receive the target RLM-RS on subband 1, subband 2 and subband 3, the terminal device will respectively determine whether a BLER corresponding to a target RLM-RS of each subband is lower than the out-of-sync threshold or is higher than the in-sync threshold according to the target RLM-RS on each subband, so as to obtain a monitoring result of each subband. In addition, if the terminal device does not receive the target RLM-RS on subband 0 within a preset time period, or found that the LBT of subband 0 is in a continuous failure state during a listening process before performing the uplink transmission on subband 0, the terminal device can consider the radio link on subband 0 as failed.

In the above solution, the terminal device monitors each subband independently and reports the monitoring result of each subband to the terminal device, so that the high layer of the terminal device can know a channel status on each subband more accurately.

In an embodiment, within the out-of-sync evaluation period, the target RLM-RS resource for monitoring the radio link quality includes the RLM-RS resource transmitting the target RLM-RS and the RLM-RS resource not transmitting the target RLM-RS. This is mainly because, within the out-of-sync evaluation period, when the terminal device measures that downlink radio link quality on a certain RLM-RS resource is poor, due to it is uncertain whether the downlink radio link quality on the RLM-RS resource being poor is because the network device does not send RLM-RS or the real downlink radio link quality is poor. Therefore, it is not necessary to distinguish whether there is a target RLM-RS transmission on the target RLM-RS resource.

For example, as shown in FIG. 4d, the BWP0 to be monitored activated by terminal device includes four subbands, which are subband 0, subband 1, subband 2 and subband 3 respectively. The subband that the network device can transmit the target RLM-RS includes subband 1, subband 2 and subband 3. The network device sends the target RLM-RS through the target RLM-RS resources on subband 1, subband 2 and subband 3 that have obtained the channel usage right. When the terminal device performs the radio link monitoring on the BWP0, it uses all the target RLM-RS resources configured within the out-of-sync evaluation period, including the RLM-RS resource that has not transmitted the target RLM-RS and the RLM-RS resource that has actually transmitted the target RLM-RS, to evaluate the radio link quality. Where, the terminal device can evaluate whether the downlink radio link quality is lower than the out-of-sync threshold according to all the above target RLM-RS resources.

Exemplarily, a BLER corresponding to the above out-of-sync threshold is 10%.

In an embodiment, the terminal device performing radio link monitoring on the BWP to be monitored according to a target RLM-RS resource on at least one subband in the plurality of subbands can further be evaluate whether downlink radio link quality estimated on the target RLM-RS resource on at least one subband is lower than a first threshold within a first evaluation period; and/or, evaluate whether downlink radio link quality on each subband estimated on the target RLM-RS resource on each subband is lower than the first threshold within the first evaluation period for each subband in the at least one subband, where the first threshold is different from an out-of-sync threshold.

Where, the terminal device may only evaluate whether the downlink radio link quality estimated on the target RLM-RS resource on at least one subband is lower than the first threshold within the first evaluation period, and for each subband in the at least one subband, it may evaluate whether the downlink radio link quality on each subband estimated on the target RLM-RS resource on each subband is lower than the first threshold only within the first evaluation period, and it further can evaluate whether the downlink radio link quality estimated on the target RLM-RS resource on at least one subband is lower than the first threshold within the first evaluation period, as well as for each subband in the at least one subband, it evaluates whether the downlink radio link quality on each subband estimated on the target RLM-RS resource on each subband is lower than the first threshold within the first evaluation period.

Specifically, the first evaluation period can be different from the in-sync evaluation period and the out-of-sync evaluation period, or the same period as the in-sync evaluation period, or the same period as the out-of-sync evaluation period.

Where, the manners for the terminal device to evaluate whether the downlink radio link quality estimated on the target RLM-RS resource on at least one subband is lower than the first threshold within the first evaluation period and/or evaluate whether the downlink radio link quality on each subband estimated on the target RLM-RS resource on each subband is lower than the first threshold within the first evaluation period for each subband in the at least one subband are similar to the judgment method in the above embodiments, and will not be repeated herein.

In addition, when the terminal device estimates the radio link quality according to the target RLM-RS resource on each subband, because subbands of BWP may include a subband that cannot receive the target RLM-RS, it may have influence on the radio link monitoring result. In order to solve this problem, the BLER corresponding to the out-of-sync threshold can be set to a value different from 10% in the prior art in the present embodiment. In one implementation, the BLER corresponding to out-of-sync threshold can be set to a value not equal to 2% and not equal to 10%. As an example rather than a limitation, the BLER corresponding to out-of-sync threshold can be set to a value greater than 10%.

In the present solution, because the radio link quality is monitored according to the first threshold, so a false report of RLF can be effectively prevented.

In an embodiment, it can be seen from the description of the above embodiments that, in an embodiment, the target RLM-RS resource can be a resource in the first RLM-RS resource, and the first RLM-RS resource is a RLM-RS resource configured on a BWP to be monitored.

In an embodiment, the network device will configure the first RLM-RS resource for the BWP to be monitored, and the first RLM-RS resource is located on each subband of the plurality of subbands of the BWP to be monitored, that is, the target RLM-RS resource configured on each subband of the plurality of subbands of the BWP to be monitored is part of the first RLM-RS resource located on the subband.

Specifically, the network device configures the first RLM-RS resource for the BWP to be monitored. Since the target RLM-RS resource is a RLM-RS resource on at least one subband in the plurality of subbands of the BWP to be monitored, thus the target RLM-RS resource can be part of the first RLM-RS resource or all of the first RLM-RS resource, or in other words, the target RLM-RS resource may be a resource located on at least one subband in the plurality of subbands in the first RLM-RS resource.

In an embodiment, RLM-RS resource is configured on each subband of the plurality of subbands, and the target RLM-RS resource includes the RLM-RS resource configured on at least one subband.

In an embodiment, RLM-RS resource including CSI-RS resource is configured on each subband of the plurality of subbands. Further In an embodiment, the CSI-RS resource configured on each subband of the plurality of subbands can be same CSI-RS resource or different CSI-RS resources.

In an embodiment, RLM-RS resource including SSB resource is configured on each subband of the plurality of subbands.

Specifically, the RLM-RS resource can be configured on each of the plurality of subbands of BWP to be monitored, and the target RLM-RS resource will include RLM-RS resource configured on the at least one subband. In one possible implementation, the target RLM-RS resource will include the RLM-RS resource configured on each subband.

In the embodiment of the present disclosure, the target RLM-RS resource includes channel state information reference signal (CSI-RS) resource and/or synchronization signal/PBCH block (SSB) resource.

Specifically, when the target RLM-RS resource includes CSI-RS resource, the network device will transmit CSI-RS through the CSI-RS resource on the subband; when the target RLM-RS resource includes SSB resource, the network device will transmit SSB through the SSB resource on the subband; and when the target RLM-RS resource includes CSI-RS resource and SSB resource, the network device will transmit CSI-RS through the CSI-RS resource on the subband and SSB through the SSB resource on the subband respectively.

The radio link monitoring method provided by the embodiments of the present disclosure, by determining a BWP to be monitored, and then by performing radio link monitoring on the BWP to be monitored according to a target RLM-RS resource on at least one subband in the plurality of subbands of the BWP to be monitored, so as to reduce the influence on the radio link monitoring result when the network device cannot send a target RLM-RS through part of the subbands, and improve the accuracy of radio link monitoring.

Next, whether the downlink radio link quality is lower than the out-of-sync threshold within the out-of-sync evaluation period, and a limitation of the out-of-sync threshold in the unlicensed spectrum will be further introduced.

Within the out-of-sync evaluation period, whether downlink radio link quality on a configured RLM-RS resource is lower than the out-of-sync threshold is evaluated. Where, the RLM-RS resource is used to transmit RLM-RS, and the out-of-sync threshold corresponds to a physical downlink control channel PDCCH transmission parameter. The PDCCH transmission parameter includes a first energy ratio, where the first energy ratio includes a ratio of a resource element (RE) energy of the PDCCH to RE energy of the RLM-RS; and/or, the first energy ratio includes a ratio of RE energy of a DMRS of the PDCCH to the RE energy of the RLM-RS.

It should be understood that in order to avoid that power of the signal transmitted on the unlicensed spectrum channel is too large, which will affect a transmission of other important signals on the channel, for example a transmission of a radar signal and so on, the communication device should follow a limitation that the signal transmission power does not exceed a maximum transmission power and a maximum transmission power spectrum density when using the unlicensed spectrum channel for performing signal transmission. Therefore, in an assumption of PDCCH transmission parameters corresponding to the out-of-sync threshold, it is unreasonable to consider power boosting of PDCCH on the unlicensed spectrum, that is, it is unreasonable that the ratio of RE energy of the PDCCH to RE energy of the RLM-RS is assumed to be 4 dB, and the ratio of RE energy of the DMRS of the PDCCH to the RE energy of the RLM-RS is assumed to be 4 dB.

In the present embodiment, in the RLM process on the unlicensed spectrum, in the assumption of PDCCH transmission parameters corresponding to the out-of-sync threshold, the above first energy ratio is 0 dB, that is, the ratio of RE energy of the PDCCH to RE energy of the RLM-RS is assumed to be 0 dB, and/or the ratio of RE energy of the DMRS of the PDCCH to the RE energy of the RLM-RS is also assumed to be 0 dB.

In an embodiment, the BLER corresponding to the out-of-sync threshold is greater than 10%. For example, a value of the BLER corresponding to the out-of-sync threshold can be 20%. In an embodiment, the value of BLER corresponding to the out-of-sync threshold is determined according to the simulation. In other words, if the terminal device is not configured by the network device with the parameters of the out-of-sync threshold that can be obtained, then a BLERₒᵤₜ and a BLERᵢₙ respectively corresponding to an out-of-sync threshold Qₒᵤₜ and an in-sync threshold Qᵢₙ can be obtained through configuration shown in Table 1. In Table 1, as an example rather than a limitation, the value of out-of-sync threshold is 20%.

TABLE 1

| configuration | BLERₒᵤₜ | BLERᵢₙ |
|---|---|---|
| 0 | 20% | 2% |

Where, RLM-RS resource include CSI-RS resource and/or SSB resource.

Specifically, when the RLM-RS resource includes CSI-RS resource, the network device will transmit CSI-RS through the CSI-RS resource on the subband; when the target RLM-RS resource includes SSB resource, the network device will transmit SSB through the SSB resource on the subband; and when the target RLM-RS resource includes CSI-RS resource and SSB resource, the network device will transmit CSI-RS through the CSI-RS resource on the subband and SSB through the SSB resource on the subband respectively.

The radio link monitoring method provided by the embodiment of the present disclosure evaluates whether downlink radio link quality on a configured radio link monitoring-reference signal RLM-RS resource is lower than an out-of-sync threshold within an out-of-sync evaluation period, where the RLM-RS resource is used to transmit RLM-RS, the out-of-sync threshold corresponds to a physical downlink control channel PDCCH transmission parameter, and the PDCCH transmission parameter includes a first energy ratio. Where, the first energy ratio is 0 dB, which makes a setting of out-of-sync threshold more reasonable and improves the accuracy of radio link monitoring.

FIG. 5 is a structural diagram of embodiment one of a terminal device provided by the present disclosure. As shown in FIG. 5, a terminal device 100 includes:

a determining module 11, configured to determine a bandwidth part BWP to be monitored, where the bandwidth part BWP to be monitored includes a plurality of subbands;

a processing module 12, configured to perform radio link monitoring on the BWP to be monitored according to a target radio link monitoring-reference signal RLM-RS resource on at least one subband in the plurality of subbands, where the target RLM-RS resource is used to transmit the target RLM-RS.

The terminal device provided by the present embodiment is used to implement the technical solution of the terminal device side in any one of the above method embodiments, and its implementation principle and technical effect are similar. by determining a BWP to be monitored, and then by performing radio link monitoring on the BWP to be monitored according to a target RLM-RS resource on at least one subband in the plurality of subbands of the BWP to be monitored, so as to reduce the influence on the radio link monitoring result when the network device cannot send a target RLM-RS through part of the subbands, and improve the accuracy of radio link monitoring.

In an embodiment, the at least one subband includes a subband transmitting the target RLM-RS in the plurality of subbands; or,

the at least one subband includes a first subband, where the first subband is a subband with a smallest index value among subbands transmitting the target RLM-RS in the plurality of subbands; or

the at least one subband includes a second subband, where the second subband is a subband with a largest index value among the subbands transmitting the target RLM-RS in the plurality of subbands.

In an embodiment, the subband transmitting the target RLM-RS in the plurality of subbands is determined by the terminal device according to instruction information sent by a network device, where the instruction information is used to determine the subband actually transmitting the target RLM-RS in the plurality of subbands.

In an embodiment, the subband transmitting the target RLM-RS in the plurality of subbands is determined by the terminal device according to a manner of blind detection of a reference signal.

In an embodiment, the at least one subband includes each subband in the plurality of subbands; or, the at least one subband includes a third subband, where the third subband is a subband preset in the plurality of subbands.

In an embodiment, the third subband is a subband including a same frequency domain resource as an initial BWP; or, the third subband is a subband with a smallest index value in the plurality of subbands; or,

the third subband is a subband with a largest index value in the plurality of subbands.

In an embodiment, the target RLM-RS resource includes the RLM-RS resource transmitting the target RLM-RS.

In an embodiment, the target RLM-RS resource includes RLM-RS resource transmitting the target RLM-RS, and/or the target RLM-RS resource includes RLM-RS resource not transmitting the target RLM-RS.

On the basis of the above embodiment shown in FIG. 5, the processing module 12 is further configured to:

determine that the target RLM-RS resource is the RLM-RS resource transmitting the target RLM-RS or the RLM-RS resource not transmitting the target RLM-RS according to blind detection of the target RLM-RS on the target RLM-RS resource.

In an embodiment, the processing module 12 is specifically configured to:

evaluate whether downlink radio link quality estimated on the target RLM-RS resource on the at least one subband is lower than an out-of-sync threshold within an out-of-sync evaluation period; and/or,

evaluate whether the downlink radio link quality estimated on the target RLM-RS resource on the at least one subband is higher than an in-sync threshold within an in-sync evaluation period.

In an embodiment, the processing module 12 is specifically configured to:

evaluate whether downlink radio link quality on the each subband estimated on the target RLM-RS resource on each subband is lower than an out-of-sync threshold within an out-of-sync evaluation period for the each subband in the at least one subband; and/or,

evaluate whether downlink radio link quality on each subband estimated on the target RLM-RS resource on the each subband is higher than an in-sync threshold within an in-sync evaluation period for the each subband in the at least one subband.

In an embodiment, the processing module 12 is specifically configured to:

evaluate whether downlink radio link quality estimated on the target RLM-RS resource on the at least one subband is lower than a first threshold within a first evaluation period; and/or,

evaluate whether downlink radio link quality on each subband estimated on the target RLM-RS resource on the each subband is lower than the first threshold within the first evaluation period for the each subband in the at least one subband, where the first threshold is different from an out-of-sync threshold.

In an embodiment, a block error rate BLER corresponding to the first threshold is greater than 10%.

In an embodiment, the target RLM-RS resource is resource of first RLM-RS resource, where the first RLM-RS resource is RLM-RS resource configured on the BWP to be monitored.

In an embodiment, each subband in the plurality of subbands is configured with a RLM-RS resource, and the target RLM-RS resource includes the RLM-RS resource configured on at least one subband.

In an embodiment, the target RLM-RS resource includes channel state information reference signal CSI-RS resource and/or in-sync signal block SSB resource.

The terminal device provided by any one of the above implementations is used to perform the technical solution of the terminal device side in any of the above method embodiments, and its implementation principle and technical effect are similar, which will not be repeated herein.

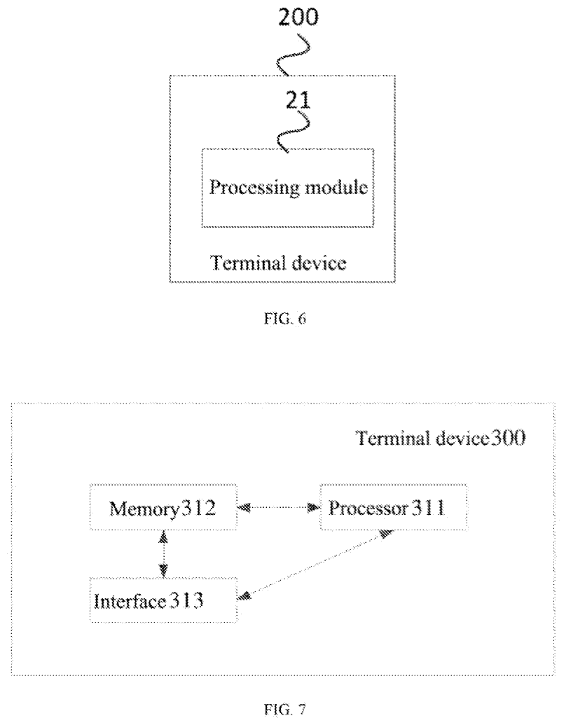

FIG. 6 is a structural diagram of embodiment two of a terminal device provided by the present disclosure. As shown in FIG. 6, a terminal device 200 includes:

a processing module 21, configured to evaluate whether downlink radio link quality on a configured radio link monitoring-reference signal RLM-RS resource is lower than an out-of-sync threshold within an out-of-sync evaluation period, where the RLM-RS resource is used to transmit RLM-RS, the out-of-sync threshold corresponds to a physical downlink control channel PDCCH transmission parameter, and the PDCCH transmission parameter includes a first energy ratio, where,

the first energy ratio includes a ratio of a resource element RE energy of the PDCCH to RE energy of the RLM-RS; and/or,

the first energy ratio includes a ratio of RE energy of a demodulation reference signal DMRS of the PDCCH to the RE energy of the RLM-RS.

In an embodiment, the first energy ratio is 0 dB.

In an embodiment, a block error rate BLER corresponding to the out-of-sync threshold is greater than 10%.

In an embodiment, the RLM-RS resource includes channel state information reference signal CSI-RS resource and/or in-sync signal block SSB resource.

The terminal device provided by any one of the above implementations is used to perform the technical solution of the terminal device side in any one of the above method embodiments, and its implementation principle and technical effect are similar, which will not be repeated herein.

FIG. 7 is a structural diagram of embodiment three of a terminal device provided by the present disclosure. As shown in FIG. 7, a terminal device 300 includes:

a processor 311, a memory 312, and an interface 313 communicating with network device;

the memory 312 stores computer an execution instruction;

the processor 311 executes the computer execution instruction stored in the memory, causing the processor 311 to execute the technical solution of the terminal device side in any one of the above method embodiments.

FIG. 7 is a simple design of the terminal device. The embodiment of the present disclosure does not limit the number of processors and memories in the terminal device. FIG. 7 only takes the number of 1 as an example for illustration.

In a specific implementation of the terminal device shown in the above FIG. 7 above, a memory, a processor and an interface can be connected through a bus. In an embodiment, the memory can be integrated inside the processor.

The embodiment of the present disclosure further provides a computer-readable storage medium, where the computer-readable storage medium stores a computer execution instruction, which, when executed by the processor, is used to implement the technical solution of the terminal device in any one of the above method embodiments.

The embodiment of the present disclosure further provides a program, which, when executed by the processor, is used to execute the technical solution of the terminal device in any one of the above method embodiments.

In an embodiment, the above processor may be a chip.

The embodiment of the present disclosure further provides a computer program product, including a program instruction, which is used to implement the technical solution of the terminal device in any one of the above method embodiments.

The embodiment of the present disclosure further provides a chip, including a processing module and a communication interface, where the processing module can execute the technical solution of the terminal device side in any one of the above method embodiments.

In an embodiment, the chip further includes a storing module (for example a memory), where the storing module is configured to store an instruction, the processing module is configured to execute the instructions stored in the storing module, and the execution of the instruction stored in the storing module causes the processing module to execute the technical solution of the terminal device side in any one of the above method embodiments.

In several embodiments provided by the present disclosure, it should be understood that the disclosed devices and methods can be realized in other manners. For example, the device embodiments described above are only schematic. For example, the division of the modules is only a logical function division. In actual implementation, there may be other division methods, for example a plurality of modules can be combined or integrated into another system, or some features can be ignored or not executed. On the other hand, the displayed or discussed mutual coupling or direct coupling or communication connection can be through some interfaces. The indirect coupling or communication connection of the modules may be in electrical, mechanical or other forms.

In a specific implementation of the above terminal device and network device, it should be understood that the processor can be a central processing unit (CPU), other general-purpose processors, digital signal processor (DSP) and disclosure specific integrated circuit (ASIC), etc. A general-purpose processor can be a microprocessor or any conventional processor, etc. The steps in combination with the method disclosed in the present disclosure can be directly embodied as being executed and completed by a hardware processor, or executed and completed by a combination of hardware and software modules in the processor.

All or part of the steps to realize each of the above method embodiments can be completed by hardware related to a program instruction. The program can be stored in a readable memory. When the program is executed, it executes steps including each of the above method embodiments. The above memory (storage medium) includes: read only memory (ROM), RAM, flash memory, hard disk, solid state disk, magnetic tape, floppy disk, optical disc and any combination thereof.

What is claimed is:

1. A radio link monitoring method, comprising:
determining a bandwidth part (BWP) to be monitored, wherein the BWP to be monitored comprises a plurality of subbands;
performing radio link monitoring on the BWP to be monitored according to a target radio link monitoring-reference signal (RLM-RS) resource on at least one subband in the plurality of subbands, wherein the target RLM-RS resource is used to transmit the target RLM-RS.

2. The method according to claim 1, wherein:
the at least one subband comprises a subband transmitting the target RLM-RS in the plurality of subbands; or,
the at least one subband comprises a first subband, wherein the first subband is a subband with a smallest index value among subbands transmitting the target RLM-RS in the plurality of subbands; or,
the at least one subband comprises a second subband, wherein the second subband is a subband with a largest index value among subbands transmitting the target RLM-RS in the plurality of subbands.

3. The method according to claim 2, wherein the subband transmitting the target RLM-RS in the plurality of subbands is determined by a terminal device according to instruction information sent by a network device, wherein the instruction information is used to determine the subband transmitting the target RLM-RS in the plurality of subbands; or,
wherein the subband transmitting the target RLM-RS in the plurality of subbands is determined by a terminal device according to a manner of blind detection of a reference signal.

4. The method according to claim 1, wherein the at least one subband comprises each subband in the plurality of subbands; or, the at least one subband comprises a third subband, wherein the third subband is a subband preset in the plurality of subbands;
wherein,
the third subband is a subband comprising a same frequency domain resource as an initial BWP; or,
the third subband is a subband with a smallest index value in the plurality of subbands; or,
the third subband is a subband with a largest index value in the plurality of subbands.

5. The method according to claim 2, wherein the target RLM-RS resource comprises RLM-RS resource transmitting the target RLM-RS.

6. The method according to claim 4, wherein the target RLM-RS resource comprises RLM-RS resource transmitting the target RLM-RS, and/or the target RLM-RS resource comprises RLM-RS resource not transmitting the target RLM-RS.

7. The method according to claim 6, wherein the method further comprises:
determining that the target RLM-RS resource is the RLM-RS resource transmitting the target RLM-RS or the RLM-RS resource not transmitting the target RLM-RS according to a blind detection of the target RLM-RS on the target RLM-RS resource.

8. The method according to claim 1, wherein the performing radio link monitoring on the BWP to be monitored according to a target RLM-RS resource on at least one subband in the plurality of subbands comprises at least one of:
evaluating whether a downlink radio link quality estimated on the target RLM-RS resource on the at least one subband is lower than an out-of-sync threshold within an out-of-sync evaluation period; and,
evaluating whether a downlink radio link quality estimated on the target RLM-RS resource on the at least one subband is higher than an in-sync threshold within an in-sync evaluation period.

9. The method according to claim 1, wherein the performing radio link monitoring on the BWP to be monitored according to a target RLM-RS resource on at least one subband in the plurality of subbands comprises at least one of:
evaluating whether a downlink radio link quality on each subband estimated on the target RLM-RS resource on the each subband is lower than an out-of-sync threshold within an out-of-sync evaluation period for the each subband in the at least one subband; and,
evaluating whether a downlink radio link quality on each subband estimated on the target RLM-RS resource on the each subband is higher than an in-sync threshold within an in-sync evaluation period for the each subband in the at least one subband.

10. The method according to claim 1, wherein the performing radio link monitoring on the BWP to be monitored according to a target RLM-RS resource on at least one subband in the plurality of subbands comprises at least one of:
evaluating whether a downlink radio link quality estimated on the target RLM-RS resource on the at least one subband is lower than a first threshold within a first evaluation period; and,
evaluating whether a downlink radio link quality on each subband estimated on the target RLM-RS resource on the each subband is lower than the first threshold within the first evaluation period for the each subband in the at least one subband, wherein the first threshold is different from an out-of-sync threshold.

11. The method according to claim 10, wherein a block error rate (BLER) corresponding to the first threshold is greater than 10%.

12. The method according to claim 1, wherein the target RLM-RS resource is resource of first RLM-RS resource, and the first RLM-RS resource is a RLM-RS resource configured on the BWP to be monitored.

13. The method according to claim 1, wherein each subband in the plurality of subbands is configured with a RLM-RS resource, and the target RLM-RS resource comprises a RLM-RS resource configured on the at least one subband.

14. The method according to claim 1, wherein the target RLM-RS resource comprises channel state information reference signal (CSI-RS) resource and/or in-sync signal block (SSB) resource.

15. A terminal device, comprising:
a processor, a memory and an interface communicating with network device:
wherein the memory stores a computer execution instruction; the processor when executing the computer execution instruction, being configured to:
determine a bandwidth part (BWP) to be monitored, wherein the BWP to be monitored comprises a plurality of subbands;
perform radio link monitoring on the BWP to be monitored according to a target radio link monitoring-reference signal (RLM-RS) resource on at least one subband in the plurality of subbands, wherein the target RLM-RS resource is used to transmit the target RLM-RS.

16. The terminal device according to claim 15, wherein,
the at least one subband comprises a subband transmitting the target RLM-RS in the plurality of subbands; or,
the at least one subband comprises a first subband, wherein the first subband is a subband with a smallest index value among subbands transmitting the target RLM-RS in the plurality of subbands; or,
the at least one subband comprises a second subband, wherein the second subband is a subband with a largest index value among the subbands transmitting the target RLM-RS in the plurality of subbands.

17. The terminal device according to claim 16, wherein the subband transmitting the target RLM-RS in the plurality of subbands is determined by the terminal device according to instruction information sent by a network device, wherein the instruction information is used to determine the subband transmitting the target RLM-RS in the plurality of subbands; or,
wherein the subband transmitting the target RLM-RS in the plurality of subbands is determined by the terminal device according to a manner of a blind detection of a reference signal.

18. The terminal device according to claim 15, wherein the at least one subband comprises each subband in the plurality of subbands; or, the at least one subband comprises a third subband, wherein the third subband is a subband preset in the plurality of subbands;
wherein,
the third subband is a subband comprising a same frequency domain resource as an initial BWP; or,
the third subband is a subband with a smallest index value in the plurality of subbands; or,
the third subband is a subband with a largest index value in the plurality of subbands.

19. The terminal device according to claim 16, wherein the target RLM-RS resource comprises RLM-RS resource transmitting the target RLM-RS.

20. The terminal device according to claim 18, wherein the target RLM-RS resource comprises RLM-RS resource transmitting the target RLM-RS, and/or the target RLM-RS resource comprises RLM-RS resource not transmitting the target RLM-RS:
and the processor is further configured to:
determine that the target RLM-RS resource is the RLM-RS resource transmitting the target RLM-RS or the RLM-RS resource not transmitting the target RLM-RS according to a blind detection of the target RLM-RS on the target RLM-RS resource.
